(19) United States
(12) Patent Application Publication
(10) Pub. No.: US 2019/0034516 A1
(43) Pub. Date: Jan. 31, 2019

(54) METHOD AND APPARATUS FOR ACQUIRING AN EVALUATION INDEX

(71) Applicant: Alibaba Group Holding Limited, Grand Cayman (KY)

(72) Inventors: Xiaoyan JIANG, Hangzhou (CN); Shaomeng WANG, Hangzhou (CN); Xu YANG, Hangzhou (CN); Ning CAI, Hangzhou (CN)

(21) Appl. No.: 16/066,102

(22) PCT Filed: Jan. 24, 2017
(86) PCT No.: PCT/CN2017/072405

§ 371 Date: Jun. 26, 2018

(30) Foreign Application Priority Data
Feb. 5, 2016 (CN) 201610082141.1

(51) Int. Cl. G06F 17/30; G06N 7/00; G06K 9/62

(52) U.S. Cl. CPC G06F 17/30598; G06F 17/30321; G06F 2216/03; G06N 7/005; G06K 9/6267; G06F 17/30539

(57) ABSTRACT

The disclosed embodiments provide a method and an apparatus for acquiring an evaluation index. The method comprises the steps of inputting samples into a classification model for classification training and acquiring output data of the classification model; acquiring probability statistics by performing probability distribution on the output data, wherein the probability statistics comprise probability intervals and a number of true positive samples and a number of true negative samples in each probability interval; and calculating the evaluation index of the classification model according to a threshold set and the acquired probability statistics. In the disclosed embodiments, probability statistics is performed for the output data of the classification model; and the evaluation index is calculated based on the acquired probability statistics, thereby solving the problem of scanning output data multiple times during the calculation of evaluation index. Particularly, the disclosed embodiments improve the calculation efficiency of the evaluation index when outputting large-scale data.

### CROSS-REFERENCE TO RELATED APPLICATIONS

This present application claims priority to Chinese Patent Application No. 201610082141.1, filed on Feb. 5, 2016, titled “Method and Apparatus for Acquiring Evaluation Index” and Int'l Application No. PCT/CN2017/072405, filed on Jan. 24, 2017, titled “Evaluation Index Obtaining Method and Device” both of which are incorporated by reference herein in their entirety.

### BACKGROUND

### Technical Field

The disclosed embodiments relate to the technical field of data processing, and, in particular, to methods and apparatuses for acquiring an evaluation index.

### Description of the Related Art

In big data mining, classification algorithms are often required to perform classification training for hyperscale data. Many classification algorithms exist currently, with different classification algorithms adopting many various variants. When a classification model is established based on a classification algorithm, the performance or accuracy of the classification model will need to be evaluated. Therefore, it is necessary to review the condition of the classification model. Currently, the evaluation indexes of binary classification algorithm model may a include confusion matrix, receiver operating characteristic curve (ROC), area under the ROC curve (AUC) value, and Lift curve.

In the current evaluation methods or systems for the classification models corresponding to the binary classification algorithms, in the process of acquiring the evaluation index, when one threshold point is inputted, the output data of the classification model needs to be scanned when calculating the evaluation parameter corresponding to the threshold point. After inputting many threshold points, the evaluation index of the classification model is then acquired. For large-scale data, scanning the output data of the classification model multiple times leads to the problem of low calculation efficiency in acquiring the evaluation index of a classification model.

### SUMMARY

The disclosed embodiments provide a method and an apparatus for acquiring an evaluation index, aiming to solve the problem of low calculation efficiency existing in acquiring the evaluation index through scanning output data of a classification model multiple times.

To achieve the above objective, the disclosed embodiments provide a method for acquiring an evaluation index, comprising: inputting samples into a classification model for classification training and acquiring output data of the classification model; acquiring probability statistics by performing probability distribution on the output data, wherein the probability statistics comprise probability intervals and a number of true positive samples and a number of true negative samples in each probability interval; and calculating the evaluation index of the classification model according to a threshold set and the acquired probability statistics.

In order to achieve the above objective, the disclosed embodiments provide an apparatus for acquiring an evaluation index, comprising: a classification training module, configured to input samples into a classification model for classification training and acquire output data of the classification model; a probability statistics module, configured to acquire probability statistics by performing probability distribution on the output data, wherein the probability statistics comprise probability intervals and a number of true positive samples and a number of true negative samples in each probability interval; and a calculation module, configured to calculate the evaluation index of the classification model according to a threshold set and the acquired probability statistics.

In the methods and apparatuses for acquiring an evaluation index provided in the disclosed embodiments, probability statistics are generated for the output data of the classification model; and the evaluation index is calculated based on the acquired probability statistics including the probability intervals and the number of corresponding true positive samples and true negative samples, thereby solving the problem of scanning output data multiple times during the calculation of evaluation index. Particularly, the disclosed embodiments improve the calculation efficiency of the evaluation index when outputting large-scale data.

### BRIEF DESCRIPTION OF THE DRAWINGS

FIG. 1 is a flow diagram illustrating a method for acquiring an evaluation index according to some embodiments of the disclosure.

FIG. 2 is a flow diagram illustrating a method for acquiring an evaluation index according to some embodiments of the disclosure.

FIG. 3 is a diagram of an application example of a method for acquiring an evaluation index according to some embodiments of the disclosure.

FIG. 4 is a diagram of an application example of a method for acquiring an evaluation index according to some embodiments of the disclosure.

FIG. 5 is a block diagram of an apparatus for acquiring an evaluation index according to some embodiments of the disclosure.

FIG. 6 is a block diagram of an apparatus for acquiring an evaluation index according to some embodiments of the disclosure.

### DETAILED DESCRIPTION OF THE EMBODIMENTS

The method and apparatus for acquiring an evaluation index provided by the disclosed embodiments are described in detail below with reference to the accompanying drawings.

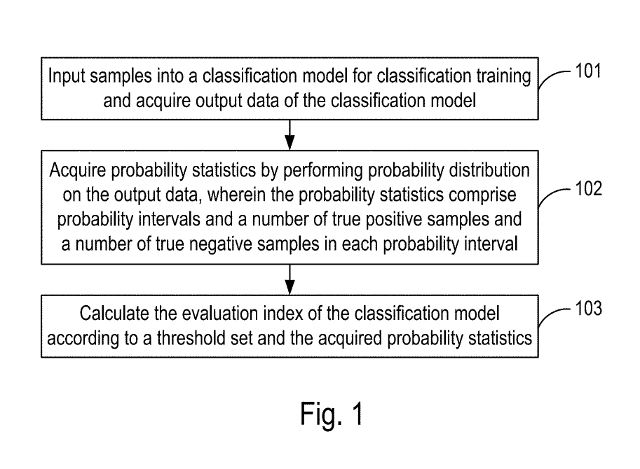

FIG. 1 is a flow diagram illustrating a method for acquiring an evaluation index according to some embodiments of the disclosure is illustrated. The illustrated method for acquiring an evaluation index comprises the following steps.

S101. Input samples into a classification model for classification training and acquire output data of the classification model.

The classification model corresponding to a binary classification algorithm classifies samples as positive samples or negative samples. In the classification model, the positive samples are shown as “1” while the negative samples are shown as “0”. Each sample inputted into the classification model has an original sample property. In this embodiment, the sample property comprises a positive sample property and a negative sample property. The original sample property indicates whether the sample is a true positive or true negative sample.

To evaluate the classification model, samples need to be inputted into the classification model for classification training. The classification model performs classification and probability prediction for each sample after the training is completed. Specifically, after the training is completed, the classification model outputs the trained sample property for each sample. The trained sample property indicates whether the sample is a positive one or a negative one after being classified through the classification model.

Furthermore, after the training is completed, the classification model performs probability prediction for each sample. Depending on a user's needs, the user can select to output the probability of each sample that the classification model predicts as a positive one. Alternatively, the user can select to output the probability of each sample that the classification model predicts as a negative one. The sum of the probabilities of the sample that the classification model predicts as a positive one (+1) and a negative one (−1) is one.

S102. Acquire probability statistics by performing probability distribution on the output data, wherein the probability statistics comprise probability intervals and a number of true positive samples and a number of true negative samples in each probability interval.

After the output data is acquired, as the classification model predicts the probability for each sample, each sample has a prediction probability in the output data. In this embodiment, the probability of each sample outputted by the classification model is the prediction probability of each sample that the classification model predicts as a positive one.

Furthermore, probability statistics can be acquired by performing a probability distribution on the output data according to the prediction probability. When performing probability statistics, it is necessary to first partition the probability intervals, and then, acquire a probability distribution graph of positive samples and negative samples by performing statistics on the number of true positive samples and true negative samples based on the original sample property of each sample in the output data of each probability interval; and acquire the number of true positive sample within each probability interval based on the probability distribution graph of positive samples and acquire the number of true negative samples within each probability interval based on the probability distribution graph of negative samples.

Preferably, a histogram of positive samples and a histogram of negative samples are acquired by performing probability distribution on the output data based on a histogram algorithm. The above probability statistics are acquired based on the histogram of positive samples and the histogram of negative samples.

S103. Calculate the evaluation index of the classification model according to a threshold set and the acquired probability statistics.

After the probability statistics are acquired, a threshold set needs to be further acquired. The threshold set comprises a plurality of threshold points, and then the evaluation parameters corresponding to each threshold point are acquired based on each threshold point and the true positive sample data and true negative sample data within each probability interval of the acquired probability statistics. The evaluation index for the classification model is generated by using the evaluation parameters corresponding to all threshold points.

In this embodiment, after the probability statistics are acquired, in the acquired probability statistics, the end point values of the probability intervals can be used as threshold points to form the threshold set. For example, the lower limit values of each probability interval can be used as threshold points to form the threshold set. Or the lower limit values of some of the probability intervals can be used as the threshold points to form the threshold set. For another example, the upper limit values of the probability intervals can be used as the threshold points to form the threshold set. In this embodiment, in the process of probability statistics, the probability intervals are partitioned. The end points of the probability intervals can be used as demarcation points, and the end point values of the probability intervals can be directly used as threshold points. As a result, there is no need to reset the threshold points, and thus the calculation efficiency of the evaluation index is improved.

Optionally, the end point values of probability intervals inputted by the user can be used as the threshold points to form the threshold set. For example, the user can select the lower limit values of each probability interval as threshold points to form the threshold set. Alternatively, the user can select the lower limit values of some of the probability interval as the threshold points to form the threshold set. In this embodiment, the user may have some preliminary understanding of the effect of the classification model based on the fed back probability statistics. Thus, the user can select proper threshold points to form the threshold set, which in turn leads to a better user interaction and more accurate evaluation on the classification model.

Furthermore, after the threshold set is acquired, the evaluation index is calculated according to the threshold points in the threshold set and the acquired probability statistics. The evaluation indexes include the confusion matrix, the ROC curve, the AUC value, and the Lift curve.

The confusion matrix includes the number of true positives (TP) being predicted as positive samples; the number of false positives (FP) being predicted as positive samples; the number of true negatives (TN) being predicted as negative samples; and the number of false negatives (FN) being predicted as negative samples.

After the threshold points are acquired, the threshold points are used as demarcation points. For the probability distribution of positive samples, true positive samples greater than the threshold points in all probability intervals are predicted as positive samples by the classification model. The numbers of the true positive samples that the classification model predicts as positive samples are accumulated; and the accumulated number of the true positive samples that the classification model predicts as positive samples are used as the TP for the confusion matrix. The true positive samples smaller than the threshold points in all probability intervals are predicted as negative samples by the classification model. The numbers of the true positive samples that the classification model predicts as negative samples are accumulated. The accumulated number of the true positive samples that the classification model predicts as negative samples are used as the FP for the confusion matrix.

For the probability distribution of negative samples, true negative samples greater than the threshold points in all probability intervals are predicted as positive samples by the classification model. The numbers of the true negative samples that the classification model predicts as positive samples are accumulated. The accumulated number of the true negative samples that the classification model predicts as positive samples are used as the FN for the confusion matrix. The true negative samples smaller than the threshold points in all probability intervals are predicted as negative samples by the classification model. The numbers of the true negative samples that the classification model predicts as negative samples are accumulated. The accumulated number of true negative samples that the classification model predicts as negative samples are used as the TN for the confusion matrix.

After acquiring the confusion matrix corresponding to the threshold point, the evaluation parameters corresponding to the threshold point of other evaluation index can be calculated by using TP, FP, TN, and FN in the confusion matrix. When the evaluation parameters corresponding to all threshold points are calculated, the evaluation index is generated by using the evaluation parameter corresponding to each threshold value. For example, the coordinates of the ROC curve at this threshold point can be calculated according to the confusion matrix corresponding to one threshold point. The coordinates can be used as the evaluation parameters of the ROC curve at the threshold point. When the evaluation parameters corresponding to all threshold points are calculated, the ROC curve can be drawn by using the ROC curve coordinates corresponding to each threshold point.

In the method for acquiring an evaluation index provided by this embodiment, probability statistics is performed on the output data of the classification model. The evaluation index is calculated based on the acquired probability statistics including the probability intervals and the number of true positive samples and the number of true negative samples in each probability interval, thereby solving the problem of scanning output data multiple times during the calculation of evaluation index. Particularly, the disclosed embodiments improve the calculation efficiency of the evaluation index when outputting large-scale data.

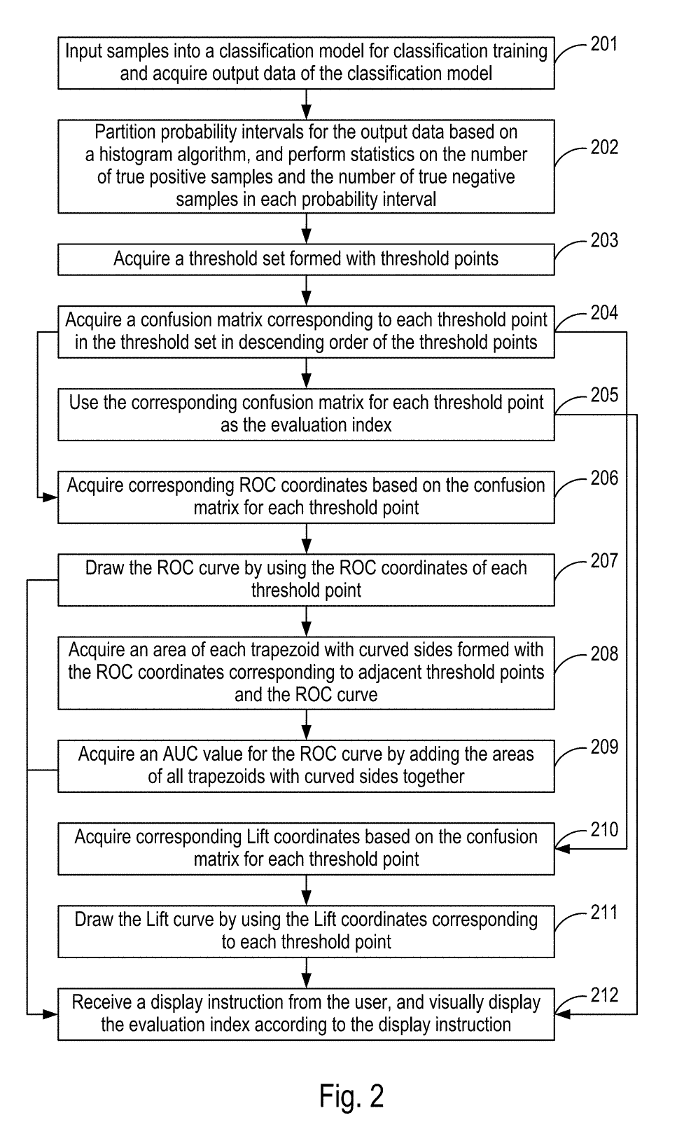

As shown in FIG. 2, a flow diagram illustrating a method for acquiring an evaluation index according to some embodiments of the disclosure is illustrated. The illustrated method for acquiring an evaluation index comprises the following steps.

S201. Input samples into a classification model for classification training and acquire output data of the classification model.

To evaluate the classification model, samples need to be inputted into the classification model for classification training; and the classification model performs classification and probability prediction for each sample after the training is completed. Specifically, after the training is completed, the classification model outputs the trained sample property for each sample. The trained sample property indicates whether the sample is a positive one or a negative one after being classified through the classification model. Furthermore, after the training is completed, the classification model performs probability prediction on each sample. The classification model usually selects to output the probability for each sample that is predicted as a positive one by the classification model.

In this embodiment, the output data of the classification model after performing classification training comprises the original sample property of each sample and the prediction probability of each sample that the classification model predicts as a positive sample. In this embodiment, the sample property comprises a positive sample property and a negative sample property. In the classification model, the positive samples are generally shown as “1” while the negative samples are shown as “0”.

S202. Partition probability intervals for the output data based on a histogram algorithm and perform statistics on the number of true positive samples and the number of true negative samples in each probability interval.

Specifically, the output data of the classification model is scanned. In this embodiment, it is assumed that the format of the output table of the classifier comprises the original sample property, sample property predicted by the classification model, and prediction probability of the samples that the classification model predicts as positive ones. Generally, the classification model can be provided with options in that either the prediction probability of the output samples that the classification model predicts as positive samples is selected or the prediction probability of the samples that the classification model predicts as positive samples is selected. Accordingly, the generation of ROC curve and Lift curve corresponding to positive samples or the generation of ROC curve and Lift curve corresponding to negative samples is optional. In this embodiment, positive samples are taken as examples.

Furthermore, a first histogram corresponding to positive samples and a second histogram corresponding to negative samples are generated according to the prediction probability of each sample that is predicted as a positive sample and the original sample property in the output data. The x-axis of the first histogram indicates the prediction probability, and the y-axis of the first histogram indicates the number of true positive samples. The x-axis of the second histogram indicates the prediction probability, and the y-axis of the second histogram indicates the number of true negative samples.

In the process of generating the first histogram and the second histogram, the probability intervals of the two histograms may be asynchronous. To acquire consistent probability intervals, the step size of the x-axis needs to be adjusted so that the probability intervals of the first histogram and the second histogram are consistent. After the probability intervals are being adjusted for consistency, the probability interval in the acquired probability statistics can be acquired.

After the probability interval is acquired, the number of true positive samples in each probability interval can be acquired from the first histogram. The number of true negative samples in each probability interval can be acquired from the second histogram.

S203. Acquire a threshold set formed with threshold points.

After the probability interval is generated, the end point values of the probability interval can be used as threshold points to form the threshold set. Optionally, the lower limit value or upper limit threshold of some of the probability intervals are used as threshold points to form the threshold set. For example, one lower limit value is selected in every other probability interval as a threshold point to form the threshold set. In this embodiment, in the process of running the probability statistics, the probability intervals are partitioned. The end points of the probability intervals can be used as demarcation points, and the end point values of the probability intervals can be used as threshold points to form the threshold set. As a result, there is no need to reset the threshold points, and thus the calculation efficiency of the evaluation index is improved.

Optionally, after the probability interval is acquired, the acquired probability statistics can be fed back to the user, who then may use the end point values of the probability interval as threshold points to form the threshold set. For example, the user can select the lower limit values of each probability interval as threshold points to form the threshold set. Alternatively, the user can select the lower limit values of some of the probability intervals as the threshold points to form the threshold set. The user may further select the end point values of some of the probability intervals as threshold points to form the threshold set. After the threshold set is acquired, the user inputs the threshold set to calculate the evaluation index. In this embodiment, through the statistics of the histograms, the user may have some preliminary understanding of the effect of the classification model based on the fed back probability statistics. Thus, the user can select proper threshold points to form the threshold set, which in turn leads to a better user interaction and more accurate evaluation on the classification model.

S204. Acquire a confusion matrix corresponding to each threshold point in the threshold set in descending order of the threshold points.

The confusion matrix comprises the number of true positive samples being predicted as positive samples TP; the number of true positive samples being predicted as negative samples FP; the number of true negative samples being predicted as negative samples TN; and the number of true negative samples being predicted as positive samples FN, as shown in Table 1 below.

### Table 1 is a schematic table of the confusion matrix.

Predicted sample property

| | | 1 | 0 |
|---|---|---|---|
| Original sample property | 1 | TP | FP |
| | 0 | FN | TN |

Specifically, regarding the first histogram that corresponds to the positive samples, the TP is acquired by accumulating the number of true positive samples greater than the threshold points in all the probability intervals based on the descending order of the threshold points. The FN is acquired by accumulating the number of true positive samples smaller than the threshold points in all the probability intervals based on the descending order of the threshold points.

Regarding the second histogram that corresponds to the negative samples, the FP is acquired by accumulating the number of negative samples greater than the threshold points in all the probability intervals based on the descending order of the threshold points, and the TN is acquired by accumulating the number of negative samples smaller than the threshold points in all the probability intervals based on the descending order of the threshold points.

S205. Use the corresponding confusion matrix for each threshold point as the evaluation index.

S206. Acquire corresponding ROC coordinates based on the confusion matrix for each threshold point.

S207. Draw the ROC curve by using the ROC coordinates of each threshold point.

S208. Acquire an area of each trapezoid with curved sides formed with the ROC coordinates corresponding to adjacent threshold points and the ROC curve.

S209. Acquire an AUC value for the ROC curve by adding the areas of all trapezoids with curved sides together.

After acquiring the confusion matrix for each threshold point, other evaluation indexes of the classification model, such as the ROC curve, the AUC value, and the Lift curve, can be acquired according to the confusion matrix.

Specifically, for each threshold point, the ratio of FP to total true negative samples is used as the X coordinate of the ROC. The ratio of the TP to the total true positive samples is used as the Y coordinate of the ROC. After the ROC coordinates corresponding to each threshold point are acquired, the ROC coordinates corresponding to all the threshold points are plotted to draw the ROC curve.

Furthermore, after the ROC curve is drawn, a trapezoid with curved sides can be formed using the ROC coordinates corresponding to adjacent threshold points and the ROC curve; and the area of one trapezoid with curved sides can be calculated according to the adjacent ROC coordinates. After the areas of all trapezoids with curved sides are acquired, the AUC value of the ROC curve can be acquired by adding all of the areas.

S210. Acquire corresponding Lift coordinates based on the confusion matrix for each threshold point.

Specifically, for each threshold point, the ratio of the sum of the TP and the FP to the total samples is used as the X coordinate of a Lift curve, and the TP is used as the Y coordinate of the Lift curve.

S211. Draw the Lift curve by using the Lift coordinates corresponding to each threshold point.

Furthermore, after the corresponding Lift coordinates of each threshold value are acquired, the Lift coordinates corresponding to all threshold points are plotted to draw the Lift curve.

S212. Receive a display instruction from the user, and visually display the evaluation index according to the display instruction.

After acquiring the evaluation index, the user can send a display instruction for displaying the evaluation index. After the display instruction is received, the calculated evaluation index is visually displayed to the user, so that the user can evaluate the condition of the classification model directly.

In this embodiment, the method for acquiring the evaluation index can be executed on a server. After the evaluation index is calculated, the user can send a display instruction to the server. After receiving the display instruction, the server can send the evaluation index to a local terminal. In this way, the local terminal visually displays the evaluation index through the display screen. For example, the local terminal displays the ROC curve, the Lift curve, and so on for the user.

Optionally, for a large-scale data, a large amount of data may be calculated on the server when using the histogram algorithm. After the calculation is done for the histogram, the results of the histogram can be sent to the local terminal and the evaluation index can be calculated at the local terminal, thereby lowering the load of the server. After the evaluation index is calculated, the user sends a display instruction to the local terminal. After receiving the display instruction, the local terminal visually displays the evaluation index through the display screen. For example, the local terminal shows the ROC curve, the Lift curve, and the like for the user. When the user clicks a point on the ROC curve, the confusion matrix corresponding to this point can be displayed.

Optionally, the method for acquiring the evaluation index can be executed at a local terminal. After the evaluation index is calculated, the user sends a display instruction to the local terminal. After receiving the display instruction, the local terminal visually displays the evaluation index on the display screen. For example, the local terminal displays the ROC curve, the Lift curve, and the like for the user. When the user clicks a point on the ROC curve, the confusion matrix corresponding to this point can be displayed.

To better understand the method for acquiring the evaluation index provided in this embodiment, the following description is given as an example: the samples are users 0-99. The sample users have the characteristic parameters described as follows: age, work class, final sampling weight (fnlwgt), education background (education_num), marital status (marital_status), occupation, relationship, race, sex, capital gain, capital loss, work hours per week, nationality, etc. These characteristic parameters of users are inputted into the classification model to perform classification training and a classification result used for user income situation can be acquired. In this example, “0” indicates low income, and “1” indicates high income. High income is used as a positive sample property, while low income is used as a negative sample property. The output data of the classification model comprises the original sample property of each sample, predicted sample property, and the probability of each sample that is predicted as high income type, as shown in Table 2 below.

### Table 2 is the output data of the classification model.

| | Original | Predicted | Probability of |
|---|---|---|---|
| Sample | sample | sample | samples predicted |
| number | property | property | as high income |
| 0 | 0 | 0 | 0.059091 |
| 1 | 0 | 0 | 0.205556 |
| 2 | 0 | 0 | 0.009091 |
| 3 | 0 | 0 | 0.026482 |
| 4 | 0 | 0 | 0.283333 |
| 5 | 0 | 0 | 0.1 |
| 6 | 0 | 0 | 0.059091 |
| 7 | 1 | 1 | 0.65235 |
| 8 | 1 | 0 | 0.475366 |
| 9 | 1 | 1 | 0.683333 |
| 10 | 1 | 1 | 0.885714 |
| 11 | 1 | 1 | 0.738889 |
| 12 | 0 | 0 | 0.023377 |
| 13 | 0 | 0 | 0.109091 |
| 14 | 1 | 1 | 0.631795 |
| 15 | 0 | 0 | 0.026482 |
| 16 | 0 | 0 | 0.009091 |
| 17 | 0 | 0 | 0.009091 |
| 18 | 0 | 0 | 0.026482 |
| 19 | 1 | 1 | 0.655556 |
| 20 | 1 | 1 | 0.975 |
| 21 | 0 | 0 | 0.009091 |
| 22 | 0 | 0 | 0.076482 |
| 23 | 0 | 0 | 0.026482 |
| 24 | 0 | 0 | 0.05 |
| 25 | 1 | 1 | 0.854762 |
| 26 | 0 | 0 | 0.02 |
| 27 | 1 | 1 | 0.744805 |
| 28 | 0 | 0 | 0.067033 |
| 29 | 0 | 0 | 0.250128 |
| 30 | 0 | 0 | 0.171429 |
| 31 | 0 | 0 | 0.009091 |
| 32 | 0 | 0 | 0.15 |
| 33 | 0 | 0 | 0.109091 |
| 34 | 0 | 0 | 0.244805 |
| 35 | 0 | 0 | 0.009091 |
| 36 | 0 | 0 | 0.009091 |
| 37 | 0 | 0 | 0.090768 |
| 38 | 1 | 1 | 0.534805 |
| 39 | 0 | 0 | 0.12735 |
| 40 | 0 | 0 | 0.026482 |
| 41 | 0 | 0 | 0.238889 |
| 42 | 0 | 0 | 0.278571 |
| 43 | 0 | 0 | 0.023377 |
| 44 | 0 | 0 | 0.009091 |
| 45 | 1 | 1 | 0.671429 |
| 46 | 0 | 0 | 0.051482 |
| 47 | 0 | 0 | 0.033333 |
| 48 | 0 | 0 | 0.24735 |
| 49 | 0 | 0 | 0.148571 |
| 50 | 0 | 0 | 0.166667 |
| 51 | 0 | 0 | 0.049091 |
| 52 | 1 | 1 | 1 |
| 53 | 1 | 1 | 0.821429 |
| 54 | 0 | 0 | 0.410684 |
| 55 | 1 | 1 | 0.869048 |
| 56 | 0 | 0 | 0.026482 |
| 57 | 0 | 0 | 0.046482 |
| 58 | 0 | 0 | 0.115768 |
| 59 | 0 | 0 | 0.076482 |
| 60 | 0 | 0 | 0.209816 |
| 61 | 0 | 0 | 0.049091 |
| 62 | 0 | 0 | 0.051482 |
| 63 | 1 | 1 | 0.975 |
| 64 | 0 | 0 | 0.028571 |
| 65 | 0 | 0 | 0.112033 |
| 66 | 0 | 0 | 0.023377 |
| 67 | 1 | 0 | 0.390768 |
| 68 | 1 | 1 | 0.724603 |
| 69 | 0 | 0 | 0.009091 |
| 70 | 0 | 0 | 0.1 |
| 71 | 0 | 0 | 0.042424 |
| 72 | 1 | 1 | 0.626482 |
| 73 | 0 | 0 | 0.009091 |
| 74 | 0 | 0 | 0 |
| 75 | 0 | 0 | 0.009091 |
| 76 | 0 | 0 | 0.090768 |
| 77 | 0 | 0 | 0.126482 |
| 78 | 0 | 0 | 0.009091 |
| 79 | 0 | 0 | 0.026482 |
| 80 | 0 | 0 | 0.009091 |
| 81 | 0 | 0 | 0.026482 |
| 82 | 0 | 0 | 0.076482 |
| 83 | 0 | 0 | 0.101482 |
| 84 | 1 | 0 | 0.458462 |
| 85 | 0 | 0 | 0.009091 |
| 86 | 1 | 1 | 0.83489 |
| 87 | 0 | 0 | 0.375366 |
| 88 | 0 | 0 | 0.009091 |
| 89 | 1 | 1 | 0.871429 |
| 90 | 0 | 0 | 0.125128 |
| 91 | 0 | 0 | 0.12 |
| 92 | 0 | 0 | 0.009091 |
| 93 | 0 | 0 | 0.166482 |
| 94 | 1 | 1 | 0.971429 |
| 95 | 0 | 0 | 0.009091 |
| 96 | 1 | 1 | 1 |
| 97 | 1 | 1 | 0.694805 |
| 98 | 0 | 0 | 0 |
| 99 | 0 | 0 | 0.009091 |

The following Table 3 and Table 4 are acquired by performing the histogram algorithm on the output data of the classification model. Table 3 is the result of the first histogram corresponding to positive samples. Table 4 is the result of the second histogram corresponding to negative samples.

### Table 3 is the result of the first histogram for the positive samples.

| | The number of positive |
|---|---|
| | samples in the |
| Probability interval | probability intervals |
| [0, 0.04) | 0 |
| [0.04, 0.08) | 0 |
| [0.08, 0.12) | 0 |
| [0.12, 0.16) | 0 |
| [0.16, 0.2) | 0 |
| [0.2, 0.24) | 0 |
| [0.24, 0.28) | 0 |
| [0.28, 0.32) | 0 |
| [0.32, 0.36) | 0 |
| [0.36, 0.4) | 1 |
| [0.4, 0.44) | 0 |
| [0.44, 0.48) | 2 |
| [0.48, 0.52) | 0 |
| [0.52, 0.56) | 1 |
| [0.56, 0.6) | 0 |
| [0.6, 0.64) | 2 |
| [0.64, 0.68) | 3 |
| [0.68, 0.72) | 2 |
| [0.72, 0.76) | 3 |
| [0.76, 0.8) | 0 |
| [0.8, 0.84) | 2 |
| [0.84, 0.88) | 3 |
| [0.88, 0.92) | 1 |
| [0.92, 0.96) | 0 |
| [0.96, 1) | 5 |

### Table 4 is the second histogram for the negative samples.

| | The number of |
|---|---|
| | negative samples |
| Probability | in the probability |
| interval | intervals |
| [0, 0.04) | 34 |
| [0.04, 0.08) | 13 |
| [0.08, 0.12) | 10 |
| [0.12, 0.16) | 5 |
| [0.16, 0.2) | 3 |
| [0.2, 0.24) | 3 |
| [0.24, 0.28) | 4 |
| [0.28, 0.32) | 1 |
| [0.32, 0.36) | 0 |
| [0.36, 0.4) | 1 |
| [0.4, 0.44) | 1 |
| [0.44, 0.48) | 0 |
| [0.48, 0.52) | 0 |
| [0.52, 0.56) | 0 |
| [0.56, 0.6) | 0 |
| [0.6, 0.64) | 0 |
| [0.64, 0.68) | 0 |
| [0.68, 0.72) | 0 |
| [0.72, 0.76) | 0 |
| [0.76, 0.8) | 0 |
| [0.8, 0.84) | 0 |
| [0.84, 0.88) | 0 |
| [0.88, 0.92) | 0 |
| [0.92, 0.96) | 0 |
| [0.96, 1) | 0 |

After the results of the first and the second histograms are acquired, probability intervals can be acquired; and the lower limit value of each probability interval is used as the threshold point to form the threshold set. In this example, the threshold set is 0, 0.04, 0.08, 0.12, 0.16, 0.2, 0.24, 0.28, 0.32, 0.36, 0.4, 0.44, 0.48, 0.52, 0.56, 0.6, 0.64, 0.68, 0.72, 0.76, 0.8, 0.84, 0.88, 0.92, and 0.96.

Only two threshold points are taken as examples here to explain the calculation process of corresponding evaluation parameters of threshold points.

When 0.4 is selected as a threshold point, the confusion matrix with the threshold point of 0.4 can be acquired according to the first and the second histograms: TP=24, FP=1, FN=1, and TN=74.

When 0.6 is selected as a threshold point, the confusion matrix with the threshold point of 0.6 can be acquired according to the first and the second histograms: TP=21, FP=4, FN=0, and TN=75.

For each threshold point, corresponding ROC coordinates and Lift coordinates can be calculated according to the confusion matrix.

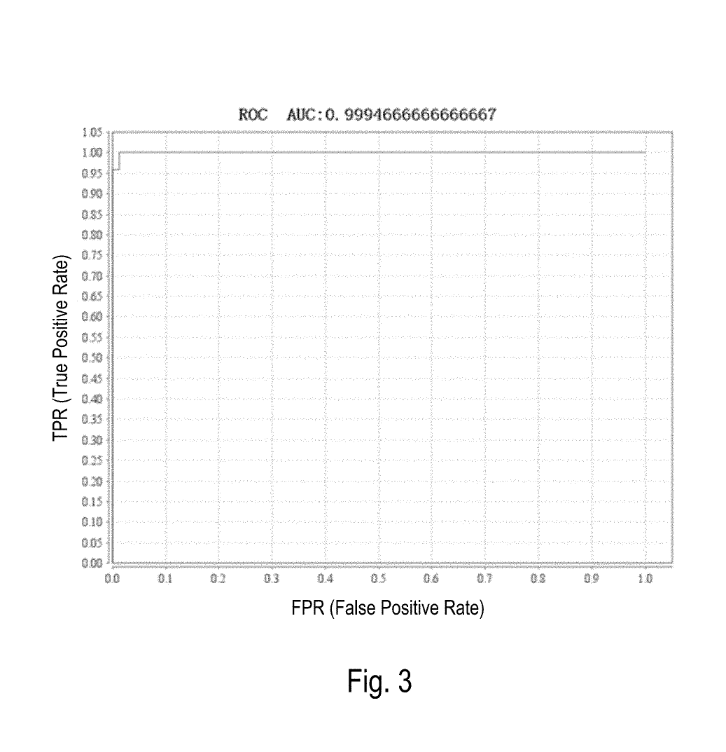

ROC coordinates: X of X coordinate=FP/(FP+TN); Y of Y coordinate=TP/(TP+FN). Lift coordinates: X of X coordinate=(TP+FN)/total samples; Y of Y coordinate=TP. After the corresponding ROC coordinates and Lift coordinates of all threshold points are acquired, the ROC curve and Lift curve can be drawn by plotting. FIG. 3 is the ROC curve of the classification model. In FIG. 3, the Y coordinate of the ROC curve is TPR (True Positive Rate) and the TPR can be used for indicating the sensitivity of the classification model in identifying positive samples. TPR=TP/(TP+FN). The X coordinate is FPR (false positive rate), wherein FPR=FP/(FP+TN). The FPR can be expressed with Specificity, FPR=1-Specificity; and Specificity is TNR (True Negative Rate), TNR=TN/(TN+FP).

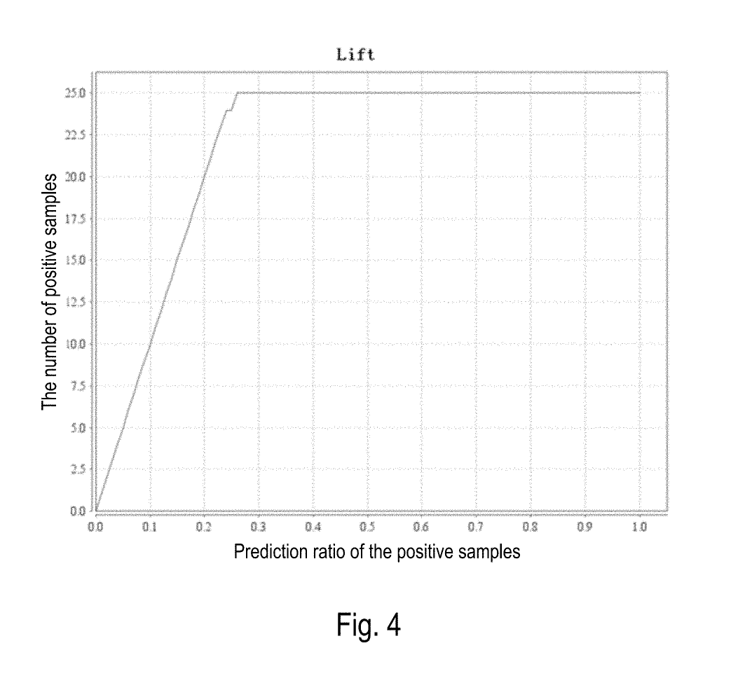

FIG. 4 is the Lift curve of the classification model. In FIG. 4, the Y coordinate indicates the number of true positive samples, and the X coordinate indicates the prediction ratio of the positive samples, which can be expressed as (TP+FN)/total samples.

After the ROC coordinates corresponding to each threshold point are acquired, the ROC curve can be drawn; a trapezoid with curved sides can be formed using the ROC coordinates corresponding to adjacent threshold points and the ROC curve. The area of one trapezoid with curved sides can be calculated according to the adjacent ROC coordinates. After the areas of all trapezoids with curved sides are acquired, the AUC value corresponding to the ROC curve can be acquired by adding all of the areas of the trapezoids with curved sides.

Codes for calculating evaluation parameters are as follows.

Input: N, icProb, icTrue, icFalse; #N is the number of probability intervals; icProb is the lower limit value of the probability interval; icTrue is the number of true positive samples in the probability interval; icFalse is the number of true negative samples in probability interval.

Output: ROC coordinates, Lift coordinates, confusion matrices, and AUC values corresponding to each threshold point;

Calculation Process:

1. Calculate the total number of the positive samples: totalTrue=Σ(icTrue); total number of the negative samples: totalFalse=Σ(icFalse)

2. Initialize the number of the accumulated positive and negative samples, curTrue=0, curFalse=0

3. For i: 0 to N
a) threshold point p=icProb[N−1-i]
b) curTrue+=icTrue[N−1-i]; curFalse+=icFalse[N−1-i] #; acquire the TP by accumulating the number of the true positive samples predicted as positive samples, and acquire the FN by accumulating the number of the true negative samples predicted as positive samples
c) confuse matrix coordinates: cm.p=p; cm.tp=curTrue; cm.fp=curFalse

cm.fn=totalTrue−curTrue; cm.tn=totalFalse−curFalse
d) ROC coordinates: roc.p=p;

roc.x=curFalse/totalFalse

roc.y=curTrue/totalTrue
e) Lift coordinates: lift.p=plift.x=(curTrue+curFalse)/(totalTrue+totalFalse)

lift.y=curTrue

4. Calculate the area under the curve (i.e., the AUC value) according to ROC coordinates.

It can be seen from the above embodiment that the confusion matrix can be calculated according to the calculation result of the histograms; and then, other evaluation indexes can be calculated conveniently based on the confusion matrix; and visual image can be generated, which enables the user to identify the good condition of the classification model directly.

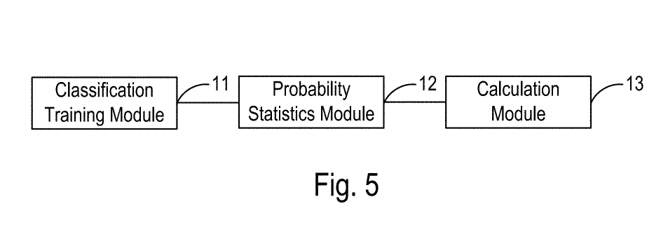

FIG. 5 is a block diagram of an apparatus for acquiring an evaluation index provided in some embodiments of the disclosure. The apparatus for acquiring an evaluation index comprises: Classification Training Module 11, Probability Statistics Module 12, and Calculation Module 13.

The Classification Training Module 11 is used for acquiring output data of a classification model by inputting samples into the classification model for classification training.

To evaluate the classification model, the Classification Training Module 11 needs to input samples into the classification model to perform classification training, and the Classification Training Module 11 then performs classification and probability prediction on each sample after the training is completed. Specifically, after the training is completed, the Classification Training Module 11 outputs the trained sample property for each sample; and the trained sample property can indicate whether the sample is a positive one or a negative one after being classified through the classification model.

Furthermore, after the training is completed, the Classification Training Model 11 performs probability prediction for each sample. Depending on the needs, a user can select to output the probability of each sample that the classification model predicts as a positive one or select to output the probability of each sample that the classification model predicts as a negative one. The sum of the probabilities of the sample that the classification model predicts as a positive one and a negative one is 1.

Each inputted sample has an original sample property. In this embodiment, the sample property comprises a positive sample property and a negative sample property. The original sample property indicates whether the sample is a true positive or true negative sample.

The Probability Statistics Module 12 is used for acquiring probability statistics by performing a probability distribution for the output data.

The probability statistics comprise probability intervals and a number of true positive samples and a number of true negative samples in each probability interval.

After the output data is acquired, as the Classification Training Module 11 predicts the probability for each sample, each sample has a prediction probability in the output data. In this embodiment, the probability of each sample outputted by the Classification Training Module 11 is the prediction probability of each sample that the classification model predicts as a positive one.

Furthermore, the Probability Statistics Module 12 is used for acquiring probability statistics by performing a probability distribution on the output data according to the prediction probability. When performing probability statistics, the Probability Statistics Module 12 is used to first partition the probability intervals; and then, acquire a probability distribution graph of positive samples and negative samples by performing statistics on the number of true positive samples and true negative samples based on the original sample property of each sample in the output data of each probability interval; and acquire the number of true positive sample within each probability interval based on the probability distribution graph of positive samples and acquire the number of true negative samples within each probability interval based on the probability distribution graph of negative samples.

Preferably, the Probability Statistics Module 12 is used to acquire a histogram of positive samples and a histogram of negative samples by performing probability distribution on the output data based on a histogram algorithm; and the above probability statistics are acquired based on the histogram of positive samples and the histogram of negative samples.

The Calculation Module 13 is configured to calculate the evaluation index of the classification model according to a threshold set and the acquired probability statistics.

After the probability statistics are acquired, a threshold set needs to be further acquired. The threshold set comprises a plurality of threshold points, and then the evaluation parameters corresponding to each threshold point are acquired based on each threshold point and the first true positive sample data and the second true negative sample data within each probability interval of the acquired probability statistics. The evaluation index for the classification model is generated by using the evaluation parameters corresponding to all threshold points.

In this embodiment, after the probability statistics are acquired, in the acquired probability statistics, the Calculation Module 13 can use the end point values of the probability intervals as threshold points to form the threshold set. For example, the lower limit values of each probability interval can be used as threshold points to form the threshold set. Or the lower limit values of some of the probability intervals can be used as the threshold points to form the threshold set. In the process of probability statistics, the probability intervals are partitioned. In this embodiment, the end points of the probability intervals can be used as demarcation points, and the end point values of the probability intervals can be directly used as threshold points. As a result, there is no need to reset the threshold points, and thus the calculation efficiency of the evaluation index is improved.

Optionally, the Calculation Module 13 can use the end point values of probability intervals inputted by the user as the threshold points to form the threshold set. For example, the user can use the lower limit value of each probability interval as threshold point to form the threshold set. Alternatively, the user may select the lower limit values of some of the probability intervals as threshold points to form the threshold set. In this embodiment, the user may have some preliminary understanding of the effect of the classification model based on the fed back probability statistics; thus the user can select proper threshold points to form the threshold set, which in turn leads to a better user interaction and more accurate evaluation on the classification model.

Furthermore, the Calculation Module 13 calculates the evaluation index according to the threshold points in the threshold set and the acquired probability statistics. The evaluation indexes include the confusion matrix, the ROC curve, the AUC value, and the Lift curve.

The confusion matrix comprises TP, FP, TN, and FN.

After the threshold points are acquired, the Calculation Module 13 uses the threshold points as demarcation points. For the probability distribution of positive samples, true positive samples greater than the threshold points in all probability intervals are predicted as positive samples by the classification model. The numbers of the true positive samples that the classification model predicts as positive samples are accumulated; and the accumulated number of the true positive samples that the classification model predicts as positive samples are used as the TP for the confusion matrix. The true positive samples smaller than the threshold points in all probability intervals are predicted as negative samples by the classification model; and the numbers of the true positive samples that the classification model predicts as negative samples are accumulated; and the accumulated number of true positive samples that the classification model predicts as negative samples are used as the FP for the confusion matrix.

For the probability distribution of negative samples, true negative samples greater than the threshold points in all probability intervals are predicted as positive samples by the classification model. The numbers of the true negative samples that the classification model predicts as positive samples are accumulated; and the accumulated number of the true negative samples that the classification model predicts as positive samples are used as the FN for the confusion matrix. The true negative samples smaller than the threshold points in all probability intervals are predicted as negative samples by the classification model; and the numbers of the true negative samples that the classification model predicts as negative samples are accumulated; and the accumulated number of true negative samples that the classification model predicts as negative samples are used as the TN for the confusion matrix.

After acquiring the confusion matrix corresponding to the threshold point, the Calculation Module 13 can perform a calculation to acquire the evaluation parameters corresponding to the threshold point of other evaluation index by using TP, FP, TN, and FN in the confusion matrix. When the evaluation parameters corresponding to all threshold points are calculated, the evaluation index is generated by using the evaluation parameter corresponding to each threshold value. For example, the coordinates of the ROC curve at this threshold point can be calculated according to the confusion matrix corresponding to one threshold point: and the coordinates can be used as the evaluation parameters of the ROC curve at the threshold point. When the evaluation parameters corresponding to all threshold points are calculated, the ROC curve can be drawn by using the ROC curve coordinates corresponding to each threshold point.

In the apparatus for acquiring an evaluation index provided in this embodiment, probability statistics is performed on the output data of the classification model; and the evaluation index is calculated based on the acquired probability statistics including the probability intervals and the number of true positive samples and the number of true negative samples in each probability interval, thereby solving the problem of scanning output data multiple times during the calculation of evaluation index. Particularly, the disclosed embodiments improve the calculation efficiency of the evaluation index when outputting large-scale data.

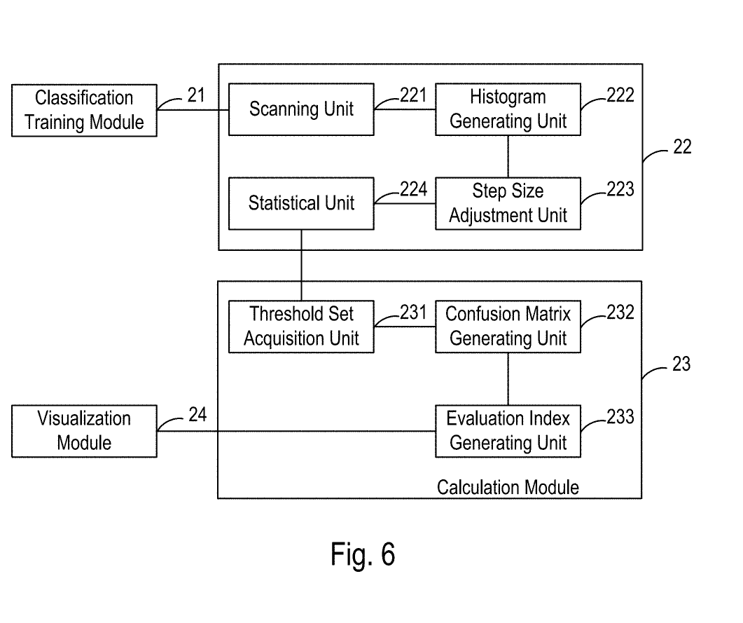

FIG. 6 is a block diagram of an apparatus for acquiring an evaluation index provided in some embodiments of the disclosure. The apparatus for acquiring an evaluation index comprises: Classification Training Module 21, Probability Statistics Module 22, Calculation Module 23, and Visualization Module 24.

The Classification Training Module 21 is configured to input samples into a classification model for classification training and acquire output data of the classification model.

Furthermore, the Probability Statistics Module 22 is specifically configured for Histogram Calculation Unit 221, which is used to partition probability intervals for the output data based on the histogram algorithm, and perform statistics on the number of true positive samples and the number of true negative samples in each probability interval.

The output data comprises: an original sample property of each sample and a prediction probability of each sample that the classification model predicts as a positive sample, wherein the sample property comprises a positive sample property and a negative sample property.

Furthermore, an optional structure of the Probability Statistics Module 22 comprises Scanning Unit 221, Histogram Generating Unit 222, Step Size Adjustment Unit 223, and Statistical Unit 224.

The Scanning unit 221 is configured to scan the output data.

The Histogram Generating Unit 222 is configured to generate a first histogram corresponding to positive samples and a second histogram corresponding to negative samples based on the prediction probability of each sample being predicted as a positive sample and the original sample property of each sample in the output data, wherein an x-axis of the first histogram indicates the prediction probability, a y-axis of the first histogram indicates a number of true positive samples. An x-axis of the second histogram indicates the prediction probability and a y-axis of the second histogram indicates the number of true negative samples.

The Step Size Adjustment Unit 223 is configured to adjust a step size of the x-axis so that the probability intervals of the first and second histograms are consistent to acquire the probability intervals in the acquired probability statistics.

The Statistical Unit 224 is configured to respectively perform statistics on the number of the true positive samples within each probability interval in the first histogram and on the number of the true negative samples within each probability interval in the second histogram.

In this embodiment, one optional structure of the Calculation Module 23 comprises Threshold Set Acquisition Unit 231, Confusion Matrix Generating Unit 232, and Evaluation Index Generating Unit 233.

The Threshold Set Obtaining Unit 231 configured to take the end point values of each probability interval as threshold points to form the threshold set.

Furthermore, the Threshold Set Acquisition Unit 231 is also configured to receive the threshold set, formed with the end point values of the probability intervals, inputted by the user.

The Confusion Matrix Generating Unit 232 is configured to acquire a confusion matrix corresponding to each threshold point in the threshold set in descending order of the threshold points, wherein the confusion matrix comprises TP, FP, TN, and FN

The Evaluation Index Generating Unit 233 is used for taking the corresponding confusion matrix of each threshold point as the evaluation index of the classification model.

After acquiring the confusion matrix for each threshold point, other evaluation indexes of the classification model, such as the ROC curve, the AUC value (the area under the ROC curve), and the Lift curve, can be acquired according to the confusion matrix.

Furthermore, the Confusion Matrix Generating Unit 232 is specifically configured to: regarding the first histogram, acquire the TP by accumulating the number of true positive samples greater than the threshold points in all the probability intervals and acquire the FN by accumulating the number of true positive samples smaller than the threshold points in all the probability intervals based on the descending order of the threshold points; and regarding the second histogram, acquiring the FP by accumulating the number of negative samples greater than the threshold points in all the probability intervals and acquire the TN by accumulating the number of negative samples smaller than the threshold points in all the probability intervals based on the descending order of the threshold points.

The Evaluation Index Generating Unit 233 is specifically configured to take the confusion matrix corresponding to each threshold point as the evaluation index.

The Evaluation Index Generating Unit 233 is specifically configured to: for each threshold point, take a ratio of the FP to the total true negative samples as an X coordinate of the ROC; take a ratio of the TP to the total true positive samples as a Y coordinate of the ROC; and draw an evaluation index ROC curve for the classification model by using the ROC coordinates corresponding to all the threshold points.

The Evaluation Index Generating Unit 233 is specifically configured to acquire an area of each trapezoid with curved sides formed with the ROC coordinates corresponding to adjacent threshold points and the ROC curve, and acquire an AUC value corresponding to the ROC curve by adding the areas of all trapezoids with curved sides together.

The Evaluation Index Generating Unit 233 is specifically configured to: for each threshold point, take a ratio of the sum of the TP and the FP to the total samples as the X coordinate of the Lift curve; and take the TP as the Y coordinate of the Lift curve; and draw an evaluation index Lift curve for the classification model by using the Lift coordinates corresponding to all threshold points.

The Visualization Module 24 is configured to receive a display instruction from the user, and visually display the evaluation index according to the display instruction.

In this embodiment, the apparatus for acquiring the evaluation index can be provided on a server to execute the method. After the evaluation index is calculated, the user can send a display instruction to the Visualization Module 24 in the apparatus. After the display instruction is received, the Visualization Module 24 can send the evaluation index to a local terminal. In this way, the local terminal visually displays the evaluation index through the display screen. For example, the local terminal displays the ROC curve, the Lift curve, and so on for the user. When the user clicks a point on the ROC curve, the confusion matrix corresponding to this point can be displayed.

Optionally, for large-scale data, in the apparatus for acquiring the evaluation index, the Classification Training Module 21 and the Probability Statistics Module 22 can be disposed on the server; the Calculation Module 23 and the Visualization Module 24 can be disposed on the local terminal, so as to lower the load of the server, thereby facilitating the interaction with the user. Classification training and histogram calculation for sample data may be carried out on the server. After the results of the histograms are acquired, the Probability Statistics Module 22 can send the histogram results to the Calculation Module 23 of the local terminal; and the Calculation Module 23 calculates the evaluation index in the local terminal, thereby lowering the load of the server. After the evaluation index is calculated, the user sends a display instruction to the Visualization Module 24. After receiving the display instruction, the Visualization Module 24 visually displays the evaluation index through the display screen. For example, the Visualization Module 24 shows the ROC curve, the Lift curve, and the like for the user. When the user clicks a point on the ROC curve, the confusion matrix corresponding to this point can be displayed.

Optionally, the apparatus for acquiring an evaluation index can be disposed on a local terminal to execute the method for acquiring an evaluation index. After the evaluation index is calculated, the user can send a display instruction to the Visualization Module 24. After receiving the display instruction, the Visualization Module 24 visually displays the evaluation index on the display screen. For example, the Visualization Module shows the ROC curve, the Lift curve, and the like for the user. When the user clicks a point on the ROC curve, the confusion matrix corresponding to this point can be displayed.

In the apparatus for acquiring an evaluation index provided by this embodiment, probability statistics is performed on the output data of the classification model. The evaluation index is calculated based on the acquired probability statistics including the probability intervals and the number of true positive samples and the number of true negative samples in each probability interval, thereby solving the problem of scanning output data multiple times during the calculation of evaluation index. Particularly, the disclosed embodiments improve the calculation efficiency of the evaluation index when outputting large-scale data. Furthermore, after acquiring the evaluation index, the evaluation index can be displayed visually, so that the user can review the good condition of the classification model directly.

Those skilled in the art can understand that all or part of the steps for implementing the method in above embodiments can be accomplished by hardware related to program instructions. The aforementioned program may be stored in a computer-readable storage medium. In execution, the program executes the steps of the method in the above embodiments, and the foregoing storage medium includes various medium that can store program codes, such as a ROM, a RAM, a magnetic disk, or an optical disc.

It should be finally noted that the above embodiments are merely used for illustrating rather than limiting the technical solutions of the disclosed embodiments. Although the present application is described in detail with reference to the foregoing embodiments, those of ordinary skill in the art should understand that the technical solutions recorded in the foregoing embodiments may still be modified or equivalent replacement may be made on part or all of the technical features therein. These modifications or replacements will not make the essence of the corresponding technical solutions be departed from the scope of the technical solutions in the disclosed embodiments.

1-22. (canceled)

23. A method comprising:
inputting, by a processor, samples into a classification model for classification training and acquiring output data of the classification model;
generating, by the processor, probability statistics by performing a probability distribution on the output data, the probability statistics comprising probability intervals, a number of true positive samples in each probability interval, and a number of true negative samples in each probability interval; and
calculating, by the processor, an evaluation index of the classification model based on a threshold set and the probability statistics.

24. The method of claim 23, the generating probability statistics by performing a probability distribution on the output data comprising
partitioning, by the processor, probability intervals for the output data based on a histogram algorithm; and
generating, by the processor, statistics on the number of true positive samples and the number of true negative samples.

25. The method of claim 24, the output data comprising an original sample property of each sample and a prediction probability for each sample that the classification model predicts as a positive sample, the sample property comprising a positive sample property and a negative sample property.

26. The method of claim 25, further comprising:
scanning, by the processor, the output data;
generating, by the processor, a first histogram corresponding to positive samples and a second histogram corresponding to negative samples based on the prediction probability of each sample being predicted as a positive sample and the original sample property of each sample in the output data, an x-axis of the first histogram indicating the prediction probability, a y-axis of the first histogram indicating a number of true positive samples, an x-axis of the second histogram indicating the prediction probability, and a y-axis of the second histogram indicating the number of true negative samples;
adjusting, by the processor, a step size of the x-axes so that the probability intervals of the first and second histograms are consistent, acquiring the probability intervals in the probability statistics;
generating, by the processor, statistics on the number of the true positive samples within each probability interval in the first histogram; and
generating, by the processor, statistics on the number of the true negative samples within each probability interval in the second histogram.

27. The method of claim 25, the calculating the evaluation index of the classification model comprising:
using, by the processor, end point values of each probability interval as threshold points to form the threshold set;
building, by the processor, a confusion matrix corresponding to each threshold point in the threshold set in descending order, the confusion matrix comprising a number of true positive samples being predicted as positive samples (TP), a number of true positive samples being predicted as negative samples (FP), a number of true negative samples being predicted as negative samples (TN), and a number of true negative samples being predicted as positive samples (FN); and
using, by the processor, the confusion matrix corresponding to each threshold point as the evaluation index.

28. The method of claim 25, the calculating the evaluation index of the classification model comprising:
receiving, by the processor, the threshold set, formed with end point values of the probability intervals, inputted by a user;
building, by the processor, a confusion matrix corresponding to each threshold point in the threshold set in descending order of the threshold points, the confusion matrix comprising a number of true positive samples being predicted as positive samples (TP), a number of true positive samples being predicted as negative samples (FP), a number of true negative samples being predicted as negative samples (TN), and a number of true negative samples being predicted as positive samples (FN); and
using, by the processor, the confusion matrix corresponding to each threshold point as the evaluation index.

29. The method of claim 27, the generating a confusion matrix comprising:
acquiring, by the processor and for the first histogram, the TP by accumulating the number of true positive samples greater than the threshold points in all the probability intervals and acquiring the FN by accumulating the number of true positive samples smaller than the threshold points in all the probability intervals based on the descending order of the threshold points; and
acquiring, by the processor and for the second histogram, the FP by accumulating the number of negative samples greater than the threshold points in all the probability intervals and acquiring the TN by accumulating the number of negative samples smaller than the threshold points in all the probability intervals based on the descending order of the threshold points.

30. The method of claim 29, further comprising, after building the confusion matrix:
using, by the processor for each threshold point, a ratio of the FP to the total true negative samples as an X coordinate of the ROC;
using, by the processor, a ratio of the TP to the total true positive samples as a Y coordinate of the ROC; and
drawing, by the processor, an evaluation index ROC curve for the classification model by using the ROC coordinates corresponding to all the threshold points.

31. The method of claim 30, wherein after drawing the evaluation index ROC curve, the method further comprises:
acquiring, by the processor, an area of each trapezoid with curved sides formed with the ROC coordinates corresponding to adjacent threshold points and the ROC curve; and
acquiring, by the processor, an AUC value corresponding to the ROC curve by adding the areas of all trapezoids with curved sides together.

32. The method of claim 29, wherein after building the confusion matrix, the method further comprises:
using, by the processor and for each threshold point, a ratio of the sum of the TP and the FP to the total samples as an X coordinate of a Lift curve;
using, by the processor, the TP as the Y coordinate of the Lift curve; and
drawing, by the processor, an evaluation index Lift curve for the classification model by using the Lift coordinates corresponding to all the threshold points.

33. An apparatus comprising:
a processor;
a storage medium for tangibly storing thereon program logic for execution by the processor, the stored program logic comprising:
logic, executed by the processor, for inputting samples into a classification model for classification training and acquiring output data of the classification model;
logic, executed by the processor, for generating probability statistics by performing a probability distribution on the output data, the probability statistics comprising probability intervals, a number of true positive samples in each probability interval, and a number of true negative samples in each probability interval; and
logic, executed by the processor, for calculating an evaluation index of the classification model based on a threshold set and the probability statistics.

34. The apparatus of claim 33, the logic for generating probability statistics by performing a probability distribution on the output data comprising
logic, executed by the processor, for partitioning probability intervals for the output data based on a histogram algorithm; and
logic, executed by the processor, for generating statistics on the number of true positive samples and the number of true negative samples.

35. The apparatus of claim 34, the output data comprising an original sample property of each sample and a prediction probability for each sample that the classification model predicts as a positive sample, the sample property comprising a positive sample property and a negative sample property.

36. The apparatus of claim 35, further comprising:
logic, executed by the processor, for scanning the output data;
logic, executed by the processor, for generating a first histogram corresponding to positive samples and a second histogram corresponding to negative samples based on the prediction probability of each sample being predicted as a positive sample and the original sample property of each sample in the output data, an x-axis of the first histogram indicating the prediction probability, a y-axis of the first histogram indicating a number of true positive samples, an x-axis of the second histogram indicating the prediction probability, and a y-axis of the second histogram indicating the number of true negative samples;
logic, executed by the processor, for adjusting a step size of the x-axes so that the probability intervals of the first and second histograms are consistent, acquiring the probability intervals in the probability statistics;
logic, executed by the processor, for generating statistics on the number of the true positive samples within each probability interval in the first histogram; and
logic, executed by the processor, for generating statistics on the number of the true negative samples within each probability interval in the second histogram.

37. The apparatus of claim 35, the logic for calculating the evaluation index of the classification model comprising:
logic, executed by the processor, for using end point values of each probability interval as threshold points to form the threshold set;
logic, executed by the processor, for building a confusion matrix corresponding to each threshold point in the threshold set in descending order, the confusion matrix comprising a number of true positive samples being predicted as positive samples (TP), a number of true positive samples being predicted as negative samples (FP), a number of true negative samples being predicted as negative samples (TN), and a number of true negative samples being predicted as positive samples (FN); and
logic, executed by the processor, for using the confusion matrix corresponding to each threshold point as the evaluation index.

38. The apparatus of claim 35, the logic for calculating the evaluation index of the classification model comprising:
logic, executed by the processor, for receiving the threshold set, formed with end point values of the probability intervals, inputted by a user;
logic, executed by the processor, for building a confusion matrix corresponding to each threshold point in the threshold set in descending order of the threshold points, the confusion matrix comprising a number of true positive samples being predicted as positive samples (TP), a number of true positive samples being predicted as negative samples (FP), a number of true negative samples being predicted as negative samples (TN), and a number of true negative samples being predicted as positive samples (FN); and
logic, executed by the processor, for using the confusion matrix corresponding to each threshold point as the evaluation index.

39. The apparatus of claim 37, the logic for generating a confusion matrix comprising:
logic, executed by the processor, for acquiring, for the first histogram, the TP by accumulating the number of true positive samples greater than the threshold points in all the probability intervals and acquiring the FN by accumulating the number of true positive samples smaller than the threshold points in all the probability intervals based on the descending order of the threshold points; and
logic, executed by the processor, for acquiring, for the second histogram, the FP by accumulating the number of negative samples greater than the threshold points in all the probability intervals and acquiring the TN by accumulating the number of negative samples smaller than the threshold points in all the probability intervals based on the descending order of the threshold points.

40. The apparatus of claim 39, further comprising:
logic, executed by the processor, for using, for each threshold point, a ratio of the FP to the total true negative samples as an X coordinate of the ROC;
logic, executed by the processor, for using a ratio of the TP to the total true positive samples as a Y coordinate of the ROC; and
logic, executed by the processor, for drawing an evaluation index ROC curve for the classification model by using the ROC coordinates corresponding to all the threshold points.

41. The apparatus of claim 40, further comprising:
logic, executed by the processor, for acquiring an area of each trapezoid with curved sides formed with the ROC coordinates corresponding to adjacent threshold points and the ROC curve; and
logic, executed by the processor, for acquiring an AUC value corresponding to the ROC curve by adding the areas of all trapezoids with curved sides together.

42. The apparatus of claim 39, further comprising:
logic, executed by the processor, for using, for each threshold point, a ratio of the sum of the TP and the FP to the total samples as an X coordinate of a Lift curve;
logic, executed by the processor, for using the TP as the Y coordinate of the Lift curve; and
logic, executed by the processor, for drawing an evaluation index Lift curve for the classification model by using the Lift coordinates corresponding to all the threshold points.
